(19) United States
(12) Patent Application Publication
(10) Pub. No.: US 2024/0172782 A1
(43) Pub. Date: May 30, 2024

(54) METHOD FOR IMPROVING QUALITY OF CURED LOIN HAM MEDIATED BY SORBITOL

(71) Applicant: Guizhou University, Guiyang (CN)

(72) Inventors: Qiujin ZHU, Guiyang (CN); Yeling ZHOU, Guiyang (CN); Ying ZHOU, Guiyang (CN); Jing WAN, Guiyang (CN); Linggao LIU, Guiyang (CN); Hongying LI, Guiyang (CN); Zhiqing TIAN, Guiyang (CN)

(21) Appl. No.: 18/107,103

(22) Filed: Feb. 8, 2023

(30) Foreign Application Priority Data
Nov. 25, 2022 (CN) 202211493403.5

(51) Int. Cl. A23L 13/40; A23L 13/60

(52) U.S. Cl. CPC A23L 13/428; A23L 13/45; A23L 13/60

(57) ABSTRACT

Disclosed is a method for improving quality of cured loin ham mediated by sorbitol, belonging to the field of food processing. The method comprises the following steps: treating loin with curing material containing sorbitol, inoculating bacterial suspension, and fermenting at constant temperature and humidity to obtain sorbitol-mediated curing loin ham. Through experiments, it is found that the salt content, pH value and a_{w} of sorbitol group are lower than those of control group in the whole production and processing process; only Lactobacillus is the dominant genus in the control group, while Staphylococcus and Lactobacillus are the dominant genera in the sorbitol group.

### CROSS-REFERENCE TO RELATED APPLICATIONS

This application claims priority to Chinese Patent Application No. 202211493403.5, filed on Nov. 25, 2022, the contents of which are hereby incorporated by reference.

### TECHNICAL FIELD

The application relates to the field of food processing, and in particular to a method for improving quality of cured loin ham mediated by sorbitol.

### BACKGROUND

Traditional dry-cured fermented meat products are usually made by rubbing a large amount of salt, spices and sugar on the surface of the meat products for curing, and then naturally fermenting (drying and ripening) for a long time with the help of endogenous enzymes and beneficial microorganisms, finally forming meat products with unique flavor, color and texture and a long shelf life. The addition of salt is very important to the texture and flavor of dry-cured meat products and to inhibit the growth of spoilage microorganisms. In order to prolong the shelf life of dry pickled meat products and maintain the taste, people usually add a lot of salt to dry-cured meat products. However, the high salt content in dry-cured meat products may produce fat oxides, which may cause oxidative stress to human body and lead to some chronic diseases related to oxidative damage. Excessive sodium intake will also increase osteoporosis, which may directly increase the risks of stroke, coronary heart disease, left ventricular hypertrophy, myocardial infarction, kidney disease, hypertension and cardiovascular diseases, which is very detrimental to human health.

Mediated curing is a new method to reduce the salt content in dry-cured meat products. Mediated curing refers to the processing strategy of systematically setting up exogenous food additives as the medium, without reducing the amount of salt, and by influencing the salt permeation and diffusion path and the water migration behavior in the matrix, so as to realize the low-sodium curing of meat products. Mechanical means such as ultra-high pressure, ultrasonic wave, pulsed electric field, rolling and kneading, electric stimulation, etc. may change the salt permeation and diffusion, which is called physical mediation. The behavior of changing the salt permeation rate and water migration by adding some chemical substances in the curing process is called exogenous substance-mediated behavior, which is a kind of chemical mediation. They are different from the traditional curing methods in the past.

Polyhydric alcohol may be used as curing medium in chemical-mediated curing because of its own structure. The molecular structure of polyhydroxy alcohol contains many hydroxyl groups, which can combine with protein in meat products, then increase the polarity of some groups in muscle protein, and convert some free water in myofibrils into bound water, which leads to the change of water distribution of products and reduces water activity. Studies have shown that polyhydroxy alcohols have antibacterial effect and may effectively inhibit the growth and reproduction of microorganisms. Sorbitol is a kind of polyhydroxy alcohol, which contains 6 hydroxyl groups, and may combine with hydroxyl groups in water in the form of hydrogen bonds, increase water retention capacity, improve texture, reduce water activity (a_{w}) and prolong the storage period of meat products. In addition, sorbitol also affects the microbial and enzyme activities in products, protein, fat degradation and the formation of final flavor, and also has antibacterial activity. At present, there are few reports on the application of polyhydroxy alcohols in reducing the salt content of dry-cured fermented meat products.

Moderate salt reduction seems to affect the growth of microorganisms and lead to changes in the physical and chemical properties of fermented meat products. For example, Gan et al. (2021) reported that during the processing of low-salt bacon, the pH value gradually decreased, and Lactobacillus became the dominant genus. A study by Chen et al. (2019b) used KCl and selected amino acids to replace 30% of NaCl(w/w) in Harbin dry-cured sausages, and analyzed the quality and microbial diversity of sausages. The results showed that the substitution salt had no negative effect on the physical properties of sausage, and the microbial diversity decreased during the fermentation of low-salt sausage. During the fermentation period, Staphylococcus and Lactobacillus were the main genera of Harbin dry sausage, and at the end of fermentation, Staphylococcus became the dominant genus of Harbin dry sausage with the highest relative abundance. However, at present, little is known about whether sorbitol may reduce the salt content and its influence on the bacterial community of dry-cured fermented meat products.

### SUMMARY

The objective of the present application is to provide a method for improving the quality of cured loin ham mediated by sorbitol, so as to solve the problems existing in the prior art. The cured loin ham mediated by sorbitol is not only beneficial to reducing the salt content of loin ham, prolonging its storage period, but also improving the distribution of bacterial community in loin ham and improving its quality.

To achieve the above objective, the present application provides the following solutions.

A method for improving quality of cured loin ham mediated by sorbitol, wherein after the loin is treated with a curing material containing the sorbitol, bacterial suspension is inoculated, and the cured loin ham mediated by the sorbitol is obtained by a fermentation under a condition of constant temperature and humidity.

Optionally, the method specifically comprises the following steps.

S1, evenly rubbing the pickling material on a surface of loin and curing at a low temperature; according to a mass of the loin, the curing material comprises the following components: 3% of NaCl, 3% of the sorbitol, 0.3% of five-spice powder, 0.3% of white pepper powder, 0.3% of pepper powder, 0.5% of white sugar and 0.5% of glucose, and a rest is the loin.

S2, inoculating the bacterial suspension into the loin cured at low temperature according to an inoculation amount of 10⁷ CFU/g, and after uniformly rolling in vacuum, stuffing the tenderloin into a casing, and hang the loin under the condition of constant temperature and humidity, and carrying out the fermentation and a culture in stages to obtain the dry-cured fermented loin ham mediated by sorbitol.

Optionally, in the S1, a low-temperature curing condition is as follows: pickling at 4° C. for 24 h.

Optionally, in the S1, the bacterial suspension is activated by bacteria L. plantarum SJ-4 and S. simulans QB7, then washed with 0.85% of physiological saline, resuspended, and then mixing according to a volume ratio of the L. plantarum SJ-4 resuspension and the S. simulans QB7 resuspension of 1:1. In addition, the present application is not limited to the above two strains, but may also be replaced by other strains belonging to the same genus.

Optionally, the L. plantarum SJ-4 is activated by de Man, Rogosa and Sharpe (MRS) broth medium; the S. simulans QB7 is activated with the MSA broth medium.

Optionally, a concentration of the L. plantarum SJ-4 heavy suspension and the S. simulans QB7 heavy suspension is 109 CFU/mL, respectively.

Optionally, carrying out the fermentation and a culture in stages is as follows: fermentation is carried out at 28° C. and 90% RH on the 1st to 2nd day of the fermentation, and then carrying out an adjustment to ripen at 15° C. and 80% RH for 20 days to an end, and the cured loin ham mediated by sorbitol is obtained on the 22nd day.

The application also provides a loin ham, which is prepared by the above method.

Optionally, the loin ham is cured by the sorbitol, so that a salt content in the loin ham is reduced and a storage period is prolonged.

The application discloses the following technical effects.

The application discloses the influence of sorbitol-mediated curing on the physicochemical properties and bacterial community composition of loin ham through experiments. The results showed that sorbitol-mediated curing had no negative effect on the physicochemical properties of loin ham. Sorbitol-mediated curing significantly reduced the salt content and a_{w} of loin ham (P<0.05), which contributed to the salt reduction of loin ham and prolonged its storage period. In addition, during the whole production process, Lactobacillus in the control group gradually occupies a dominant position, while Lactobacillus and Staphylococcus in the sorbitol group are evenly distributed, which indicated that sorbitol-mediated pickling could promote the growth of Staphylococcus or inhibit the overgrowth of Lactobacillus, so that the dominant microorganisms in the loin ham are evenly distributed and the quality of loin ham is improved. Therefore, the application provides a preliminary perspective for the potential development of low-salt fermented meat products in the food industry, and achieves satisfactory results.

### BRIEF DESCRIPTION OF THE DRAWINGS

In order to more clearly explain the embodiments of the present application or the technical solutions in the prior art, the following will briefly introduce the drawings to be used in the embodiments. Obviously, the drawings in the following description are only some embodiments of the present application. For those of ordinary skill in the art, other drawings may be obtained according to these drawings without any creative effort.

FIG. 1A shows the changes of pH of different groups of loin ham during fermentation and ripening, “C” in the legend represents the control group, and “S” represents the sorbitol group; different lowercase letters (a-h) indicate that there are significant differences among different groups with different fermentation durations and ripening durations (P<0.05).

FIG. 1B shows the changes of salt content of different groups of loin ham during fermentation and ripening, “C” in the legend represents the control group, and “S” represents the sorbitol group; different lowercase letters (a-h) indicate that there are significant differences among different groups with different fermentation durations and ripening durations (P<0.05).

FIG. 1C shows the changes of Aw of different groups of loin ham during fermentation and ripening, “C” in the legend represents the control group, and “S” represents the sorbitol group; different lowercase letters (a-h) indicate that there are significant differences among different groups with different fermentation durations and ripening durations (P<0.05).

FIG. 1D shows the changes of WHC of different groups of loin ham during fermentation and ripening, “C” in the legend represents the control group, and “S” represents the sorbitol group; different lowercase letters (a-h) indicate that there are significant differences among different groups with different fermentation durations and ripening durations (P<0.05).

FIG. 2A shows the changes of the number of Lactobacillus plantarum during the fermentation and ripening of different groups of loin ham; “C” in the legend represents the control group, and “S” is the sorbitol group; different lowercase letters (a-d) indicate that there are significant differences among different groups with different fermentation durations and ripening durations (P<0.05).

FIG. 2B shows the changes of the number of Staphylococcus aureus during the fermentation and ripening of different groups of loin ham; “C” in the legend represents the control group, and “S” is the sorbitol group; different lowercase letters (a-d) indicate that there are significant differences among different groups with different fermentation durations and ripening durations (P<0.05).

FIG. 2C shows the changes of the number of total aerobic bacteria during the fermentation and ripening of different groups of loin ham; “C” in the legend represents the control group, and “S” is the sorbitol group; different lowercase letters (a-d) indicate that there are significant differences among different groups with different fermentation durations and ripening durations (P<0.05).

FIG. 3 shows the taxonomic composition of phylum bacteria during the fermentation and ripening of loin ham (TOP 15).

FIG. 4 shows the taxonomic composition of generic bacteria during the fermentation and ripening of loin ham (TOP 15).

FIG. 5 is Circos diagram of loin ham.

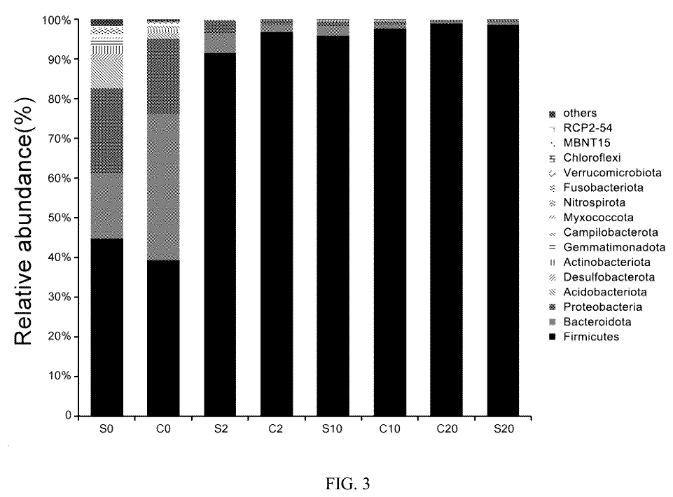

In FIG. 3-FIG. 5, S0: sorbitol group fermented for 0 days; S2, the sorbitol group is fermented for 2 days; S10: sorbitol group ripened for 10 days; S20: the sorbitol group ripened for 20 days; CO: the control group fermented for 0 days; C2: the control group fermented for 2 days; C10: the control group ripened for 10 days; C20: the control group ripened for 20 days.

### DETAILED DESCRIPTION OF THE EMBODIMENTS

Various exemplary embodiments of the present application will be described in detail. This detailed description should not be taken as a limitation of the present application, but should be understood as a more detailed description of some aspects, characteristics and embodiments of the present application.

It should be understood that the terms mentioned in the present application are only used to describe specific embodiments, and are not used to limit the present application. In addition, for the numerical range in the present application, it should be understood that each intermediate value between the upper limit and the lower limit of the range is also specifically disclosed. Every smaller range between any stated value or the intermediate value within the stated range and any other stated value or the intermediate value within the stated range is also included in the present application. The upper and lower limits of these smaller ranges may be independently included or excluded from the range.

Unless otherwise stated, all technical and scientific terms used herein have the same meanings commonly understood by those of ordinary skill in the field to which this application relates. Although the present application only describes preferred methods and materials, any methods and materials similar or equivalent to those described herein may be used in the practice or testing of the present application. All documents mentioned in this specification are incorporated by reference to disclose and describe the methods and/or materials related to the documents. In case of conflict with any incorporated documents, the contents of this specification shall prevail.

Without departing from the scope or spirit of the present application, it is obvious to those skilled in the art that many modifications and changes may be made to the specific embodiments of the present specification. Other embodiments obtained from the description of the present application will be obvious to the skilled person. The specification and embodiment of this application are only exemplary.

As used in this paper, the terms “including”, “having” and “containing” are all open terms, meaning including but not limited to.

### Embodiment 1

### 1. Materials

Pork loin is purchased from Tainong loin in Huimin Fresh Supermarket, Huaxi District, Guiyang City. The main ingredients of pig's drinking materials are corn, sorghum and soybean. After feeding about 250 kg of daily ration and stocking for more than 365 days, the pigs are slaughtered, and tenderloin is sold by Tainong Xingwang Group Co., Ltd. (Guiyang, China). Food-grade sodium chloride, five-spice powder, pepper powder, white pepper powder, glucose and white sugar are all purchased from Wal-Mart in Huaxi, Guiyang City, food-grade sorbitol is purchased from Shandong Tianli Pharmaceutical Co., Ltd., and the casing is purchased from Yumu Group. Other chemicals and reagents selected in this application are of analytical grade or higher, and are acquired in Aladdin.

Medium: MRS broth medium, Mannitol salt agar (MSA) broth medium (5 g of beef paste powder, 10 g of peptone, 10 g of D-mannitol, 75 g of sodium chloride, 0.025 g of phenol red, 1000 mL of pure water, adjusting pH to 7.2-7.5), MRS agar medium, MSA agar medium and Plate Count Agar (PCA) medium are all purchased from Shanghai Bowei Biotechnology Co., Ltd.

### 2. Methods

### 2.1 Activation and Preparation of Strains

L. plantarum SJ-4 (strain conservation number: CICC No. 11119s, which has been published in the patent “direct-throwing starter for meat with high load of lactic acid bacteria and its preparation method and application”), S. simulans QB7 (strain conservation number: CICC No. 1117s, which has been published in the document “Isolation and characterization of coagulase negative staphylococci with high proteolytic activity from dry fermented sausages as a potential starter culture”), all of which are selected from fermented meat products in Guizhou by the laboratory, and kept by China Industrial Microbial Culture Collection Management Center. MRS broth medium is used to activate SJ-4 and MSA liquid medium to activate QB7. After the strains are activated for four generations, the strains are washed three times with 0.85% normal saline, and then resuspended and adjusted to the concentration of 109 CFU/mL for the subsequent preparation of fermented loin ham.

### 2.2 Technological Process of Fermented Loin Ham

Pork loin is cut into cubes of about 100 g on average (n=24). The formula of pickling material is based on the weight of raw meat (W/W), adding 3% of NaCl, 3% of food-grade sorbitol (not added in the control group), 0.3% of five-spice powder, 0.3% of white pepper powder, 0.3% of pepper powder, 0.5% of white sugar and 0.5% of glucose, kneading it evenly on the surface of tenderloin, and placing it at 4° C. for 24 h, so that the seasoning mixture is evenly distributed in the meat. The activated SJ-4 and QB7 bacterial suspension is inoculated into the meat (10⁷ CFU/g) at the ratio of 1:1, and after rolling in vacuum for 30 min, the tenderloin is stuffed into the collagen casing with a diameter of 45 mm, and immediately hung in the fermentation cabinet with constant temperature and humidity. For the first two days, the tenderloin ham is fermented at 28° C. and 90% RH. Then, the fermentation cabinet is set at 15° C. and 80% RH to ripen the loin ham for 20 days, and the loin ham product is obtained after 22 days of processing. Samples are taken at 0 days of fermentation, 2 days (after fermentation), 10 days of ripening period (middle ripening period) and 20 days (late ripening period) respectively. Samples (each with three parallel groups) are collected at each time point to compare the physical and chemical characteristics and the dynamic changes of bacterial community of loin ham at different fermentation time and ripening time.

### 2.3 Measurement of Physical and Chemical Properties

### 2.3.1 pH Value

Weighing 1 g of minced meat sample, diluting it 10 times with deionized water, homogenizing it with XHF-D homogenizer (Ningbo Xinzhi Biotechnology Co., Ltd., Zhejiang, China) at 2800 r/min for 1 min, making it completely homogenized, and using PHS-3C digital pH meter to determine the pH value.

### 2.3.2 Salt Content

Weighing 1 g of minced meat sample, diluting it 10 times with deionized water, homogenize it with XHF-D homogenizer (Ningbo Xinzhi Biotechnology Co., Ltd., Zhejiang, China) at 2800 r/min for 1 min, making it completely homogenized, and then measuring it with ATAGO ES-421 digital salinity meter. The actual NaCl content is expressed as g/100 g meat.

### 2.3.3 Water Activity

Using saturated sodium chloride and saturated magnesium chloride solution to calibrate the water activity (a_{w}) instrument. Then, weighing 5 g of minced meat, spreading the minced meat evenly in a small Petri dish, and measuring the minced meat by a_{w} measuring instrument (Huake HD-4B, Wuxi, China).

### 2.3.4 Cooking Loss

Cutting the marinated tenderloin into meat samples of a certain size, weighing 2-3 g of meat samples as M₁, then putting them in a retort pouch, sealing them in a water bath at 80° C., and heat them for 20 min; when the center temperature of the meat samples reaches 75° C., taking them out, rinsing them with running water and cooling them to room temperature, absorbing the surface water with absorbent paper, and weighing M₂. Use the following formula to calculate:

$$Cooking loss = \frac{M 1 - M 2}{M 1} \times 100 \% .$$

### 2.3.5 Color Difference

Using NH350 Agilent portable computer colorimeter for determination. Cutting the pickled fillet into slices, and measuring its brightness L*, redness a* and yellowness b*.

### 2.4 Bacteria Count

In a clean bench, after taking out the tenderloin ham from the casing, removing the spices on the surface and adding a sample (10 g) from the center of tenderloin ham into a sterile homogenization bag, and then adding 90 mL of sterile normal saline (0.85% of NaCl), which is sealed and homogenized (12.0/s, 5 min). Diluting the homogenized liquid for coating and measuring the numbers of lactic acid bacteria, Staphylococcus and total aerobic bacteria on MRS, MSA and PCA media respectively. After culturing at 37° C. for 36 h, counting the lactic acid bacteria and total aerobic bacteria on MRS and PCA plates, and counting Staphylococcus on MSA plate after incubation at 37° C. for 48 h.

### 2.5 Total DNA Extraction and PCR Amplification

According to the manufacturer's instructions, extracting the genomic DNA of the sample by DNA extraction kit (D6356-F-96-SH), and then quantifying by agarose gel electrophoresis and NanoDrop2000. According to the selection of sequencing area, using specific primers with barcode and Tks-Gflex DNA polymerase of Takara for PCR to ensure the amplification efficiency and accuracy. Identifying the bacterial diversity by analyzing the V3-V4 hypervariable region of 16S rRNA gene. Using primers 343F and 798R, the forward primer: 5′-TACGGRAGGCAGCAG-3′ and the reverse primer: 5′-AGGGTATCTAATCCT-3′ for amplification. Using two-step cyclic PCR for amplification (reference of amplification method: Nossa, C. W. (2010). Design of 16S rRNA gene primers for 454 pyrosequencing of the human foregut microbiome. World Journal of Gastroenterology, 16(33), 4135-4144. https://doi.org/10.3748/wjg.v16.i33.4135.). Finally, according to the concentration of PCR products, mixing the aliquot samples, and analyzing the 16S rRNA in the purified mixed samples by high-throughput sequencing through Illumina Novaseq6000 and PE250 platform (Ouyi Biotechnology Company, Shanghai, China).

### 2.6 Bioinformatics Analysis

The original sequencing data is in FASTQ format. Then using cutadapt software to preprocess the paired end readings to detect and cutting off the adapter. After pruning, using DADA2 (the default parameter is QIME2 (November, 2020)) to filter low-quality sequences, denoise, merge, and detecting and cutting off chimera reading. Finally, the software outputs representative readings and ASV abundance table.

Using QIIME to calculate the a diversity of samples, including richness index (ACE and Chao1), diversity index (Shannon and Simpson) and Coverage index; using R software to draw stacked histogram, Circos diagram and cluster heat map of dominant genera among visual samples.

### 2.7 Data Analysis

Using one-way analysis of variance (ANOVA) for statistical analysis, and then performing Duncan multi-range test. When P<0.05, the difference is considered significant. All data are analyzed by SPSS 17 software (SPSS in Chicago, Illinois, USA) and GraphPad Prism 8 (GraphPadSoftware Inc, California, USA), and the results are expressed as average value±standard deviation.

### 3. Results and Analysis

### 3.1 Changes of Physical and Chemical Properties During the Production of Fermented Loin Ham

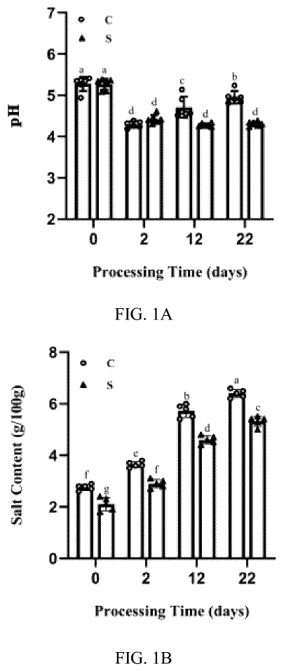

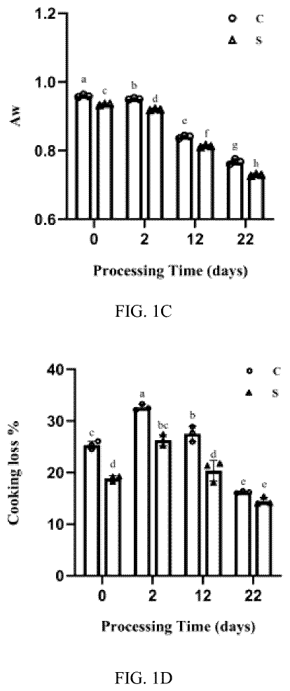

(1) During the whole processing process, the pH of control group and sorbitol group decreases from 5.28 and 5.26 to 4.95 and 4.31, respectively (FIG. 1A). In all groups, the pH value of loin ham decreases rapidly during fermentation. At the ripening period, the pH of the control group increases slowly, while that of the sorbitol group decreases gently until the end of ripening period. The pH of loin ham drops rapidly, which is due to the addition of Lactobacillus plantarum to produce acid in meat products. It is this rapid acidification that effectively inhibits the growth of spoilage microorganisms in food and is very important to improve the quality and safety of fermented meat products. In the present application, there is no significant difference in pH value between the control group and sorbitol group in fermentation period and middle ripening period (P>0.05), but in the late ripening period, the pH value of sorbitol group is significantly lower than that of the control group (P<0.05), which may be due to the oxidation of sorbitol in meat products for a long time, and part of it is converted into sorbic acid, resulting in a low pH value.
(2) As shown in FIG. 1B, the salt content of loin ham has been on the rise during the production and processing. At the end of ripening period, the salt content of control group and sorbitol group reaches 6.34 g/100 g and 5.32 g/100 g. The increase of salt content is due to the diffusion of salt and the gradual decrease of water content in meat products. When the solution decreases, the solute increases. The salt content of sorbitol group is significantly lower than that of the control group (P<0.05) in both fermentation and ripening periods, indicating that sorbitol affected the permeation and diffusion of salt in meat products and water migration behavior. This may be because sorbitol remains on the cell surface due to its excessive molecular weight and high viscosity, so its diffusion rate is slower than that of salt. With the high extracellular osmotic pressure, a high viscosity barrier of sorbitol (“barrier effect”) is formed on the surface of the product, and a solute film that hinders the diffusion of sodium chloride is formed, thus reducing the salt content. Another possible reason is that the hydroxyl groups of sorbitol combine with the hydroxyl groups of water in the matrix in the form of hydrogen bonds, and the interaction accelerates the diffusion rate of sorbitol while slowing down the free diffusion of water. The number of water molecules interacting with NaCl decreases, so the content of Na⁺ entering cells also decreases, which leads to the decrease of salt content in the whole matrix.
(3) As shown in FIG. 1 C, the a_{w} of loin ham shows a downward trend in the whole production process. At the end of ripening period, the a_{w} of control group and sorbitol group decreased from 0.965 and 0.935 to 0.764 and 0.729 respectively (P<0.05). During the whole fermentation and ripening period, the a_{w} of sorbitol group is significantly lower than that of the control group (P<0.05). This may be because sorbitol is a humectant, and its molecular structure contains many hydroxyl groups, which may combine with protein in meat products, then increase the polarity of some groups in muscle protein, convert some free water in myofibrils into bound water and reduce the content of free water in meat products. Therefore, the moisture distribution of the product changes and a_{w} is reduced.
(4) As shown in FIG. 1 D, the cooking loss of sorbitol group is significantly lower than that of the control group after 0 day of fermentation, 2 days of fermentation and 10 days of ripening (P<0.05). This is because sorbitol is a humectant and may increase the water holding capacity (WHC) of meat products. However, there is no significant difference in the cooking loss rate between the control group and sorbitol group at the end of ripening (P>0.05), which may be due to the low water content in the end of ripening due to the gradual evaporation of water in meat products, so there is little difference in water holding capacity.
(5) The color of meat products mainly depends on protein composition (myoglobin content), protein denaturation, water content, pH value, fat content, etc. As shown in Table 1, with the progress of fermentation and maturation, the L* values of all groups gradually decrease, while the a* and b* values increase (P<0.05). The decrease of L* value may be attributed to the dehydration of meat products, and the L* value is easily affected by the moisture content. The lower the moisture content, the lower the L* value. During the fermentation and ripening, the L* values of sorbitol group are always higher than that of the control group (P<0.05), because sorbitol contained six hydroxyl groups, and its hydroxyl groups combined with the hydroxyl groups of water in meat products in the form of hydrogen bonds, thus increasing its WHC.

TABLE 1
Color changes of different groups of tenderloin
ham during fermentation and ripening

| | | Fermentation duration (d) | | Ripening duration (d) | |
|---|---|---|---|---|---|
| Color | Group | 0 | 2 | 10 | 20 |
| L*-value | C | 48.27 ± 0.97^{b} | 42.65 ± 0.75^{c} | 35.48 ± 0.57^{e} | 33.68 ± 0.92^{e} |
| | S | 50.94 ± 0.83^{a} | 48.55 ± 1.26^{ab} | 41.13 ± 1.43^{c} | 38.62 ± 0.88^{d} |
| a*-value | C | 9.41 ± 0.30^{d} | 13.10 ± 0.40^{bc} | 16.37 ± 0.77^{a} | 17.08 ± 0.59^{a} |
| | S | 9.34 ± 0.20^{d} | 11.89 ± 0.26^{c} | 13.38 ± 0.78^{b} | 13.94 ± 0.58^{b} |
| b*-value | C | 1.93 ± 0.26^{ef} | 2.99 ± 0.38^{cd} | 4.55 ± 0.22^{ab} | 5.14 ± 0.36^{a} |
| | S | 1.45 ± 0.14^{f} | 2.50 ± 0.29^{de} | 3.33 ± 0.29^{c} | 4.13 ± 0.21^{b} |

Note:
C: control group, S: sorbitol group.
The results are expressed as a standard error of mean (S.E.M).
Different lowercase letters (a-f) indicate that there are significant differences among different groups with different fermentation durations and ripening durations (P < 0.05).

(6) The a* value of all groups gradually increases during the ripening process, which may be related to the formation of nitroso myoglobin under the action of bacteria, mainly because NO₂³⁻ in meat products is reduced to NO²⁻, and NO²⁻ is decomposed into NO and combined with myoglobin to form nitroso myoglobin, which make meat products bright and bright red. In addition, during the ripening process, the a* values of the control group are always bigger than that of the sorbitol group (P<0.05), which may be related to lactic acid bacteria and pH value. The number of lactic acid bacteria in the control group is significantly higher than that of the sorbitol group (P<0.05). Studies have shown that some lactic acid bacteria may promote the formation of zinc protoporphyrin IX(ZnPP), which may be used to improve the redness of fermented meat products, and the amount of ZnPP formed in the presence of acid with pH>4.75 significantly increases, so the low pH of sorbitol group may have an impact on the a* values.

The increase of b* value may be due to the yellow pigment produced by the reaction between the products of lipid oxidation and the amine in phospholipid head group or the amine in protein. The b* value of the control group is higher than that of the sorbitol group (P<0.05) during the ripening process, which may be due to the fact that sorbitol can delay lipid oxidation and reduce related products of lipid oxidation.

### 3.2 Bacteria Community Count

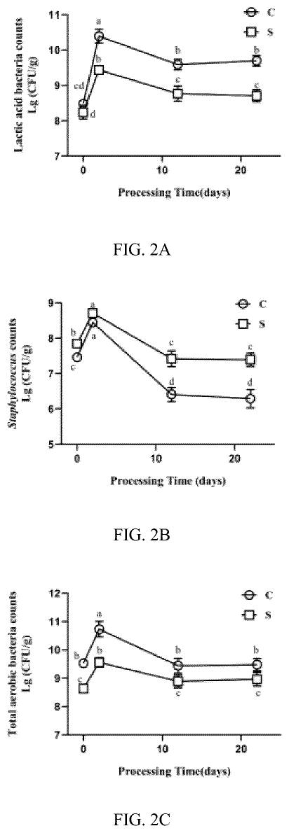

During fermentation, the number of LAB, Staphylococcus and TACs (total aerobic bacteria) in the control group and sorbitol group increases exponentially (P<0.05), and the highest level reaches at the end of fermentation. In addition, due to the good adaptability to meat substrate, the number of LAB and Staphylococcus increased rapidly (FIGS. 2A-B), but the number of LAB, Staphylococcus and TACs decrease significantly in the maturation period compared with the fermentation stage (P<0.05). This is because the fermentation period gives the optimum temperature and humidity for microbial growth. During this period, microorganisms will rapidly consume nitrogen and carbon sources in tenderloin ham to achieve rapid growth. However, the temperature and humidity in the ripening period is not the optimum temperature and humidity for microbial growth, and a lot of nitrogen, carbon and water sources have been consumed in loin ham, so the total number of bacteria in the ripening period is significantly lower than that in the fermentation period (P<0.05).

From the end of fermentation to the end of ripening, the number of LAB in the control group is significantly higher than that in the sorbitol group (P<0.05), while the number of Staphylococcus is significantly lower than that in the sorbitol group (P<0.05). This may be because the addition of sorbitol inhibited the growth of LAB and promoted the growth of Staphylococcus. TACs still shows a high quantity in meat products inoculated with starter, which indicated that other microorganisms also grew well in the samples inoculated with starter. At the ripening period of fermentation, the TACs of the control group is significantly higher than that of the sorbitol group (P<0.05) (FIG. 2 C), indicating that sorbitol-mediated curing may inhibit the growth of TACs.

### 3.3. Alpha Diversity of Bacterial Community During the Fermentation and Ripening of Loin Ham

1,777,040 high-quality and effective sequences are collected from all 24 samples of fermented ham, of which 891,256 and 885,784 valid readings are obtained in control group and sorbitol group, respectively. Table 2 shows the a diversity index, ASV richness and sample coverage of bacteria. It can be seen from the table that all the samples have a good coverage rate (>99.9%), indicating that the sequencing depth has basically covered all the species in the loin ham samples. ASVs, ACE and Chao1 indices are generally used to reflect the richness of flora, while Shannon and Simpson indices generally reflect the species diversity of communities. These values show a downward trend in the fermentation and ripening periods, indicating that the abundance and diversity of microorganisms gradually decreased with the progress of fermentation and ripening. At the end of ripening period, the Simpson index of sorbitol group is significantly higher than that of the control group (P<0.05), which means that the microbial diversity of sorbitol is higher than that of the control group. This result indicates that sorbitol-mediated curing may increase the diversity of microbial communities. In addition, there is no significant difference in ASVs, ACE and Chao1 indexes among the groups at the end of ripening period (P>0.05). Because the sample is not fermented naturally, but inoculated with starter to ferment, it is credible that a subset of bacteria dominates the tenderloin ham sample.

TABLE 2
Alpha diversity indexes in samples of loin ham.

| | | Species abundance index | | Species diversity index | | Sample coverage |
|---|---|---|---|---|---|---|
| Samples | ASVs | ACE | Chao1 | Simpson | Shannon | rate |
| C0 | 260.33 ± 64.71^{a} | 261.04 ± 65.65^{a} | 260.95 ± 64.16^{a} | 0.98 ± 0.01^{a} | 6.72 ± 0.62^{a} | 99.994% ± 0.00003^{ab} |
| C2 | 120.00 ± 19.87^{bc} | 120.60 ± 19.99^{bc} | 119.99 ± 19.89^{bc} | 0.56 ± 0.04^{bc} | 1.96 ± 0.91^{cd} | 99.999% ± 0.00001^{a} |
| C10 | 153.00 ± 69.78^{bc} | 154.15 ± 70.37^{bc} | 153.02 ± 69.89^{bc} | 0.42 ± 0.03^{bc} | 1.45 ± 0.09^{cd} | 99.998% ± 0.00001^{a} |
| C20 | 83.33 ± 9.03^{c} | 84.03 ± 12.7^{c} | 83.50 ± 8.97^{c} | 0.37 ± 0.04^{c} | 1.10 ± 0.20^{d} | 99.996% ± 0.00001^{a} |
| S0 | 186.00 ± 39.00^{ab} | 187.71 ± 39.45^{ab} | 186.09 ± 38.91^{ab} | 0.86 ± 0.03^{a} | 4.53 ± 0.41^{b} | 99.996% ± 0.00001^{b} |
| S2 | 124.33 ± 24.23^{bc} | 125.16 ± 24.71^{bc} | 124.62 ± 24.34^{bc} | 0.62 ± 0.15^{b} | 2.37 ± 0.74^{c} | 99.997% ± 0.00001^{a} |
| S10 | 102.67 ± 22.53^{bc} | 103.26 ± 21.91^{bc} | 102.65 ± 22.59^{bc} | 0.59 ± 0.16^{b} | 2.14 ± 0.79^{cd} | 99.999% ± 0.00000^{a} |
| S20 | 89.00 ± 18.38^{bc} | 88.89 ± 17.13^{bc} | 88.94 ± 18.36^{bc} | 0.62 ± 0.04^{b} | 1.94 ± 0.11^{cd} | 99.999% ± 0.00001^{a} |

Note: It is expressed as SEM. Different lowercase letters (a-d) in the same column indicate significant differences (P < 0.05). C0: the control group fermented for 0 day; C2: the control group fermented for 2 days; C10: the control group ripened for 10 days; C20: the control group ripened for 20 days; S0: sorbitol group fermented for 0 day; S2, the sorbitol group is fermented for 2 days; S10: sorbitol group ripened for 10 days; S20: The sorbitol group ripened for 20 days.

### 3.4 Bacterial Community Composition of Loin Ham During Fermentation and Ripening

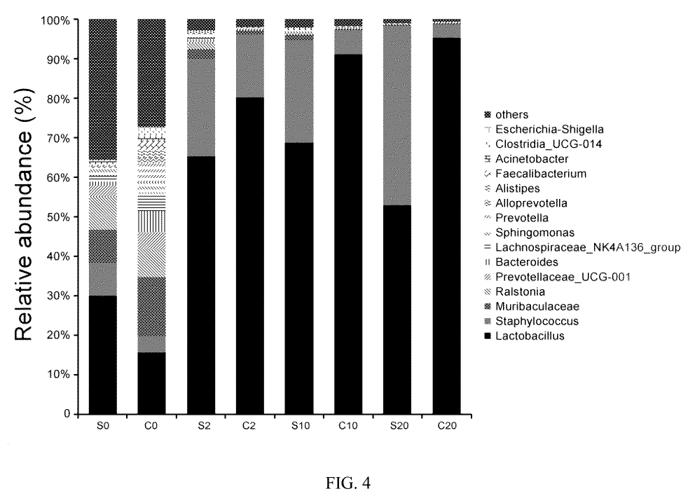

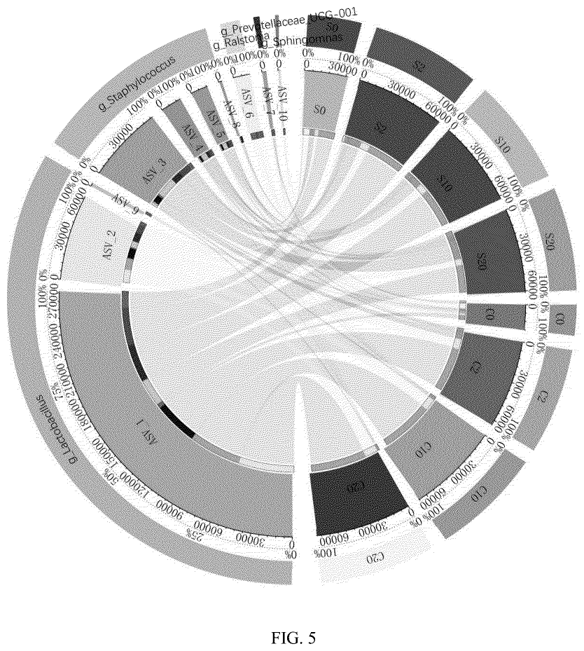

(1) As shown in FIG. 3, the relative abundance of bacterial communities at phylum level. During fermentation and ripening, the percentage of phylum distribution and the relative abundance of bacterial community in loin ham changes. Bacterial community diversity is the richest in the samples fermented for 0 days. Firmicutes, Bacteroidetes and Proteobacteria are observed in group CO, accounting for 39.39%, 36.62% and 19.22% of the whole sequence, respectively. In group S0, Firmicutes, Bacteroidetes and Proteobacteria accounts for 42.75%, 16.20% and 21.64% of the whole sequence, respectively. With the increase of fermentation and ripening duration, the relative abundance of Firmicutes in all groups increased, and is significantly higher than that of other phylum (P<0.05). For example, in the control group and sorbitol group, it increases from 39.39% and 42.75% at the initial stage of fermentation to 98.94% and 98.58% at the end of maturation period. On the other hand, the relative abundance of Bacteroidetes and Proteobacteria decreases gradually, which indicates that from fermentation to ripening period, the Firmicutes is dominant in loin ham samples. One reason why Firmicutes is dominant is that they may produce spores and may resist dehydration and extreme environment. Another reason is that the Firmicutes contains both Lactobacillus plantarum and Staphylococcus, which is consistent with the results of the relative abundance of bacterial communities at the latter genus level.
(2) As shown in FIG. 4-FIG. 5, it is the relative abundance and Circos of bacterial communities of genus level. Obviously, Lactobacillus, Staphylococcus, Muribaculaceae, Ralstonia, Prevotellaceae_UCG-001, Bacteroides and Lachnospiraceae NK4A136 group show high relative abundance at 0 days of fermentation in all groups. The relative abundance of Muribaculaceae, Ralstonia, Prevotellaceae_UCG-001, Bacteroides, Lachnospiraceae NK4A136 group, Sphingomonas, Prevotella, Alloprevotella, Alistipes, Faecalibacterium, Acinetobacter, Clostridia_UCG-014 and Escherichia-Shigella decrease rapidly (FIG. 4). This indicates that several microorganisms related to spoilage, including Acinetobacter, Clostridia_UCG-014 and Escherichia-Shigella, are inhibited in the loin ham inoculated with starter. The above-mentioned bacteria related to spoilage are generally considered as the meat spoilage factors leading to the production of undesirable metabolites and odor compounds. Therefore, controlling spoilage bacteria may be an effective way to improve the quality of meat products. In this study, the number of Lactobacillus is higher than that of Staphylococcus, and the large growth of Lactobacillus may inhibit the proliferation of other pathogenic microorganisms, which has a positive impact on the safety of low-salt ham. With the progress of fermentation and maturation, the number of other microorganisms decreased, while Lactobacillus and Staphylococcus gradually increased, becoming the most important bacteria in all groups. This may be due to inoculation of starter cultures in all groups, which helps to increase the antibacterial metabolites produced by Lactobacillus and Staphylococcus, and the competition with other bacteria for nutrients intensifies, resulting in their inhibition of the growth of other bacteria.

In the fermentation and ripening period, Lactobacillus in the control group is significantly higher than that in the sorbitol group (P<0.05), while Staphylococcus in the sorbitol group is significantly higher than that in the control group (P<0.05). Circos diagram shows that sorbitol-mediated curing changed the relative abundance of bacteria in loin ham (FIG. 5). Especially at the end of ripening period, the proportion of Lactobacillus in control group and sorbitol group reaches 95.26% and 52.88% respectively, and the proportion of Staphylococcus in control group and sorbitol group reaches 3.45% and 45.38% respectively. This indicates that sorbitol may inhibit the growth of Lactobacillus and promote the growth of Staphylococcus, which may be due to its antibacterial effect, which may reduce the number of miscellaneous bacteria and inhibit the growth of some microorganisms, while Staphylococcus has antibacterial activity and may resist the antibacterial effect of sorbitol. Therefore, Lactobacillus and Staphylococcus in sorbitol group are distributed evenly.

Microbial flora contributes a lot to the fermentation of dry-cured fermented meat products, especially in the ripening period. Besides Lactobacillus is an ideal microorganism, Staphylococcus is also the main bacteria group in the fermentation of meat products, which is very important in the fermentation and ripening of meat products. Under the action of proteolytic enzymes and lipases, these bacteria may increase the flavor of products, and may also prevent the peculiar smell and rancidity caused by the antioxidant activities. According to the application, L. plantarum SJ-4 and S. simulans QB7 are inoculated into the loin ham mediated by sorbitol, which not only enhances the competitive ability of two dominant bacteria, namely Lactobacillus and Staphylococcus, improves the relative abundance of beneficial bacteria in loin ham, but also inhibits the growth of harmful bacteria (pathogens and spoilage bacteria), which is helpful to improve the quality of loin ham.

The above-mentioned embodiments only describe the preferred mode of the application, but do not limit the scope of the application. On the premise of not departing from the design spirit of the application, all kinds of modifications and improvements made by ordinary technicians in the field to the technical scheme of the application shall fall within the scope of protection determined by the claims of the application.

What is claimed is:

1. A method for improving quality of cured loin ham mediated by sorbitol, wherein after the loin is treated with a curing material containing the sorbitol, bacterial suspension is inoculated, and the cured loin ham mediated by the sorbitol is obtained by a fermentation under a condition of constant temperature and humidity.

2. The method according to claim 1, wherein the method specifically comprises following steps:
S1, evenly rubbing the curing material on a surface of loin and curing at a low temperature; according to a mass of the loin, wherein the curing material comprises the following components: 3% of NaCl, 3% of the sorbitol, 0.3% of five-spice powder, 0.3% of white pepper powder, 0.3% of pepper powder, 0.5% of white sugar and 0.5% of glucose, and a rest is the loin.
S2, inoculating the bacterial suspension into the loin cured at a low temperature according to an inoculation amount of 10⁷ CFU/g, and after uniformly rolling in vacuum, stuffing the tenderloin into a casing, hanging the loin under the condition of constant temperature and humidity, and carrying out the fermentation and a culture in stages to obtain the dry-cured fermented loin ham mediated by sorbitol.

3. The method according to claim 2, wherein in the S1, the low-temperature pickling condition is as follows: curing at 4 degree Celsius (° C.) for 24 h.

4. The method according to claim 2, wherein in the S1, the bacterial suspension is activated by bacteria L. plantarum SJ-4 and S. simulans QB7, then washed with 0.85% of physiological saline, resuspended, and then mixed according to a volume ratio of the L. plantarum SJ-4 resuspension and the S. simulans QB7 resuspension of 1:1.

5. The method of claim 4, wherein the L. plantarum SJ-4 is activated by de Man, Rogosa and Sharpe (MRS) broth medium; and the S. simulans QB7 is activated with the Mannitol salt agar (MSA) broth medium.

6. The method according to claim 4, wherein a concentration of the L. plantarum SJ-4 heavy suspension and the S. simulans QB7 heavy suspension is 109 CFU/mL, respectively.

7. The method according to claim 2, wherein carrying out the fermentation and a culture in stages is as follows: fermentation is carried out at 28° C. and 90% RH on the 1st to 2nd day of the fermentation, and then adjusted to mature at 15° C. and 80% RH for 20 days to an end, and the pickled tenderloin ham mediated by sorbitol is obtained on a 22nd day.

8. A loin ham prepared by the method of claim 1.

9. The loin ham according to claim 8, wherein the loin ham is cured by the sorbitol, so a salt content in the loin ham is reduced and a storage period is prolonged.
